(19) United States
(12) Patent Application Publication
(10) Pub. No.: US 2014/0296386 A1
(43) Pub. Date: Oct. 2, 2014

(54) THERMOPLASTIC POLYESTER RESIN COMPOSITION AND MOLDED ARTICLE THEREOF

(71) Applicant: TORAY RESIN COMPANY, Shelbyville, IN (US)

(72) Inventors: Yasuo MAEDA, Shelbyville, IN (US); Dennis GODWIN, Shelbyville, IN (US); Jason KAISER, Shelbyville, IN (US); Hiroshi SATO, Shelbyville, IN (US); Kenji OTA, Shelbyville, IN (US)

(73) Assignee: TORAY RESIN COMPANY, Shelbyville, IN (US)

(21) Appl. No.: 13/853,626

(22) Filed: Mar. 29, 2013

(51) Int. Cl. C08L 67/02

(52) U.S. Cl. CPC C08L 67/02
USPC 523/456; 524/111

(57) ABSTRACT

A thermoplastic polyester resin composition having: 100 parts by weight total of a resin composition, wherein the resin composition has 75 to 99 wt % of (A) a polybutylene terephthalate resin, and 1.0 to 25 wt % of (B) a polyester elastomer resin and/or an olefin elastomer; and 0.01 to 5 parts by weight of (C) a sorbitan fatty acid ester. The thermoplastic polyester resin composition is useful for making electric/electronic device parts, automobile parts and machine parts, as well as connectors.

### FIELD OF INVENTION

The present invention relates to a thermoplastic polyester resin composition, which is excellent in flexibility and useful for employment in electric/electronic device parts, automobile parts and machine parts, as well as connectors made thereof.

### BACKGROUND OF THE INVENTION

As thermoplastic polyester resins generally exhibit excellent mechanical properties, heat resistance and moldability, such resins are widely used in, for example, automobile parts, films and electric/electronic device parts. In particular, the flexibility of a polybutylene terephthalate resin, which is a type of polyester resin, can be highly improved when in combination with a polyester elastomer resin and is excellent in chemical resistance. Thus, polybutylene terephthalate resins are widely used as materials for industrial molded articles, such as connectors used for automobiles and electric/electronic devices. Recently, demand for a connector with a reduced size and complicated structure has been increasing. A connector with a reduced size and complicated structure tends to have more thin-wall structure portions, which causes problems in injection molding due to stagnation of the resin flow and/or nonuniform and turbulent resin flow in front of the thin-wall structure molding section. Consequently, the molded article tends to develop or have cracks in the thin-wall structure portion due to lack of resin adhesiveness. Meanwhile, it has also been desired that the molded article have flexibility without any cracking even if there are portions causing resin flow stagnation in front of thin structure portions. Although published Patent Application (JP 2009-173899A) discloses that a polyester elastomer resin is added to a polybutylene terephthalate resin, this document is silent regarding technology in improving resin adhesiveness at thin structure portions. Also, published Patent Application (JP Hei 06-184410A) discloses a resin composition made by adding a sorbitan fatty acid ester to a polybutylene terephthalate resin. However, this document does not disclose technology where a sorbitan fatty acid ester is used to improve the resin adhesiveness of a polybutylene terephthalate resin and a polyester elastomer resin.

### BRIEF SUMMARY OF THE INVENTION

An objective of the present invention is to provide a polybutylene terephthalate resin composition and a connector made thereof which are excellent in flexibility and resin adhesiveness. The inventors have diligently researched to accomplish the objective and reached the present invention. The invention is described as follows.

(1) A thermoplastic polyester resin composition comprises 100 parts by weight of a resin composition constituting 75 to 99 wt % of (A) a polybutylene terephthalate resin and 1.0 to 25 wt % of (B) a polyester elastomer resin and/or an olefin elastomer; and 0.01 to 5 parts by weight of (C) a sorbitan fatty acid ester.

(2) The thermoplastic polyester resin composition defined in above item (1) may contain as the sorbitan fatty acid ester (C) a sorbitan monostearate, a sorbitan distearate or a sorbitan tristearate.

(3) The thermoplastic polyester resin composition defined in above item (1) or (2) may contain (B) an olefin elastomer that is a mixture of (b1) a copolymer containing a glycidyl group made of α-olefin and α, β-glycidyl esters of unsaturated acids and of (b2) a copolymer formed by copolymerization of 2 or more types of α-olefins, and with respect to the total of (A) component and (B) component in the resin composition, (b1) is in a range of 0.5 to 24.5 wt % and (b2) is in a range of 0.5 to 24.5 wt %.

(4) A molded article may be made of the thermoplastic polyester resin composition in above items (1), (2) or (3).

(5) A connector may be made of the thermoplastic polyester resin composition defined in above items (1), (2), or (3), or the molded article of (4).

The thermoplastic polyester resin composition of the present invention is excellent in flexibility and resin adhesiveness, and can suitably be used as material for parts with a complicated shape/structure, such as connectors.

### BRIEF DESCRIPTION OF THE DRAWING

FIG. 1 shows a schematic diagram of the Izod impact test conditions applied to a test sample of each example, including the comparative examples.

### DETAILED DESCRIPTION OF THE INVENTION

An element of the invention, the polybutylene terephthalate resin (A), is a polymer which is obtained by a normal polymerization, such as a polycondensation reaction between terephthalic acid or ester-forming derivatives thereof and 1,4-butanediol or ester-forming derivatives as primary components, and which can include some amount of other components of copolymer unless the desired properties are diminished, such as for example an amount of not more than 20 parts by weight. As preferable examples of the polymer and the copolymer, the following can be named: polybutylene terephthalate, polybutylene (terephthalate/isophthalate), polybutylene (terephthalate/adipate), polybutylene (terephthalate/sebacate), polybutylene (terephthalate/decane dicarboxylate), polybutylene (terephthalate/naphthalate), poly(butylene/ethylene) terephthalate. These can be used alone or as a combination of two or more.

The polybutylene terephthalate resin (A) used in the invention preferably has an intrinsic viscosity of 0.60 to 1.60, more preferably 0.80 to 1.30, where the viscosity is measured with o-chlorophenol solution of the polybutylene terephthalate resin at 25° C. If the intrinsic viscosity is less than 0.60, the mechanical properties are poor and the intrinsic viscosity of more than 1.60 provides a poor moldability.

As manufacturing process of the polybutylene terephthalate resin (A) used in the present invention, common polycondensation processes or ring-opening polymerization can be used and either batch polymerization or continuous polymerization can be applied. Also, either transesterification reaction or direct polymerization can be applied. However, continuous polymerization is preferable in terms of the capability of reducing the amount of carboxyl end groups and increasing fluidity, and the direct polymerization is preferable in terms of reducing costs. Use of a polymerization reaction catalyst is preferable to promote an esterification reaction or transesterification reaction and a polycondensation reaction. Examples of the polymerization catalyst include organic titanium compounds such as methyl ester, tetra-n-propyl ester, tetra-n-butyl ester, tetraisopropyl ester, tetraisobutyl ester, tetra-tert-butyl ester, cyclohexyl ester, phenyl ester, benzyl ester, and tolyl ester of titanium acid, and mixtures thereof; tin compounds such as dibutyltin oxide, methyl phenyltin oxide, tetraethyltin, hexaethyl ditin oxide, cyclohexahexyl ditin oxide, didodecyltin oxide, triethyltin hydroxide, triphenyltin hydroxide, triisobutyltin acetate, dibutyltin diacetate, diphenyltin dilaurate, monobutyltin trichloride, dibutyltin dichloride, tributyltin chloride, dibutyltin sulfide, and butyl butylhydroxytin oxide, as well as alkyl stannonic acids including methyl stannonic acid, ethyl stannonic acid, and butyl stannonic acid; zirconia compounds such as zirconium tetra-n-butoxide; and antimony compounds such as antimony trioxide, and antimony acetate. Of these, organic titanium compounds and tin compounds are preferable, and tetra-n-propyl ester, tetra-n-butyl ester and tetraisopropyl ester of titanium acid are more preferable. In particular, tetra-n-butyl ester of titanium acid is highly preferable. These polymerization catalysts may be used singly or as a mixture of two or more thereof. The content of these polymerization catalysts is preferably in the range of 0.005 to 0.5 parts by weight, more preferably 0.01 to 0.2 parts by weight, relative to 100 parts by weight of the polybutylene terephthalate resin from the viewpoint of mechanical properties, moldability and color tone.

The content of the polybutylene terephthalate resin (A) is 75 to 99 wt % of the total of (A) component and (B) component in the resin composition. If the content of the polybutylene terephthalate resin is less than 75 wt %, the fluidity of the thermoplastic polyester resin composition is poor, and more than 99 wt % content makes the toughness and the durability of the thermoplastic polyester resin composition poor.

As the polyester elastomer resin (B), the following can be used: polyether ester block copolymer where a hard segment is an aromatic polyester and a soft segment is a poly(alkylene oxide)glycol and/or aliphatic polyester, a polyester ester block copolymer, a polyether ester-ester block copolymer. The aromatic polyester functioning as a hard segment is a polymer which is produced through a polycondensation reaction between a dicarboxylic acid component normally including not less than 60 mol % of terephthalic acid component and a diol component. Examples of preferable aromatic polyesters include polyethylene terephthalate, polybutylene terephthalate, polyethylene (terephthalate/isophthalate), polybutylene (terephthalate/isophthalate). Examples of a poly(alkylene oxide)glycol and/or aliphatic polyester which constitute a soft segment include polyethylene glycol, poly(1,2- and 1,3-propylene oxide)glycol, poly(tetramethylene oxide)glycol, copolymer of ethylene oxide and propylene oxide, copolymer of ethylene oxide and hydrofuran, polyethylene adipate, polybutylene adipate, poly-ε-caprolactone, polyethylene sebacate, and polybutylene sebacate.

The ratio of the hard segment to the soft segment of polyester in polyester elastomer is 95/5-10/90, preferably 90/10-30/70, in the ratio by weight. Examples of preferable polyester elastomer resins include polyethylene terephthalate.poly(tetramethylene oxide)glycol block copolymer, polyethylene terephthalate/isophthalate.poly(tetramethylene oxide)glycol block copolymer, polybutylene terephthalate.poly(tetramethylene oxide)glycol block copolymer, polybutylene terephthalate/isophthalate.poly(tetramethylene oxide)glycol block copolymer, polybutylene terephthalate/decane dicarboxylate.poly(tetramethylene oxide)glycol block copolymer, polybutylene terephthalate.poly(propylene oxide/ethylene oxide)glycol block copolymer, polybutylene terephthalate/isophthalate.poly(propylene oxide/ethylene oxide)glycol block copolymer, polybutylene terephthalate/decane dicarboxylate.poly(propylene oxide/ethylene oxide)glycol block copolymer, and polybutylene terephthalate.poly(ethylene oxide)glycol block copolymer. In particular, of these polyester elastomer resin, polybutylene terephthalate.poly(tetramethylene oxide)glycol block copolymer, and polybutylene terephthalate/isophthalate.poly(tetramethylene oxide)glycol block copolymer are preferably used.

Examples of the (B) olefin elastomer used in the present invention include, ethylene/propylene copolymer, ethylene/1-butene copolymer, ethylene/1-octene copolymer, ethylene/propylene/conjugated diene copolymer, ethylene/ethyl acrylate copolymer, ethylene/butyl acrylate copolymer, ethylene/methacrylic acid copolymer, ethylene/glycidyl acrylate copolymer, ethylene/glycidyl methacrylate copolymer, ethylene/methyl acrylate/glycidyl methacrylate copolymer, ethylene/ethyl acrylate/glycidyl methacrylate copolymer, ethylene/vinyl acetate/glycidyl methacrylate copolymer, ethylene/ethyl acrylate-g-methyl methacrylate/butyl acrylate copolymer, ethylene/ethyl acrylate-g-methyl methacrylate copolymer, ethylene/ethyl acrylate-g-maleic anhydride copolymer, ethylene/methyl acrylate-g-maleic anhydride copolymer, ethylene/ethyl acrylate-g-maleimide copolymer, ethylene/propylene-g-maleic anhydride copolymer, ethylene/butene-1-g-maleic anhydride copolymer and the like, and these can each be used independently or in the form of a mixture.

More preferable in the (B) olefin elastomer is a mixture of (b1) a copolymer containing a glycidyl group made of α-olefin and α-, β-glycidyl esters of unsaturated acids and (b2) a copolymer formed by copolymerization of 2 or more types of α-olefins. Examples of the α-olefin of the (b1) copolymer containing a glycidyl group made of α-olefin and α-, β-glycidyl esters of unsaturated acids include ethylene, propylene, butene-1, pentene-1 and the like, and among these, ethylene is preferably used. Examples of the α-, β-glycidyl esters of unsaturated acids include glycidyl acrylate, glycidyl methacrylate, glycidyl ethacrylate, glycidyl itaconatev and the like, and among these, glycidyl methacrylate is preferably used. Specific examples of the copolymer containing a glycidyl group include ethylene/glycidyl acrylate copolymer, ethylene/glycidyl methacrylate copolymer, ethylene/methyl acrylate/glycidyl methacrylate copolymer, ethylene/ethyl acrylate/glycidyl methacrylate copolymer, and ethylene/vinyl acetate/glycidyl methacrylate copolymer, and among these, ethylene/glycidyl methacrylate copolymer and ethylene/methyl acrylate/glycidyl methacrylate copolymer are preferred. The content of (b1) component is preferably 0.5 to 24.5 wt %, more preferably 2 to 10 wt % of the total of (A) component and (B) component in the resin composition.

Examples of α-olefins of the (b2) copolymer formed by copolymerization of 2 or more types of α-olefins include ethylene, propylene, butene-1, pentene-1 and the like, and ethylene/propylene copolymer, ethylene/1-butene copolymer, ethylene/1-octene copolymer, and ethylene/propylene/conjugated diene copolymer are specific examples α-olefin copolymers. Among these, ethylene/1-butene copolymer and ethylene/1-octene copolymer are preferred. The content of (b2) component is preferably 0.5 to 24.5 wt %, more preferably 2 to 10 wt % of the total of (A) component and (B) component in the resin composition.

The (B) elastomer content is 1.0 to 25 wt % of the total of (A) component and (B) component in the resin composition. When the content is less than 1.0 wt %, resin composition toughness and durability are poor, and when the content is more than 25 wt %, resin composition liquidity is poor. From the perspective of liquidity, toughness, and durability, adding in the range of 1.5 to 20 wt % is preferred, and in the range of 2.0 to 10 wt % is more preferred.

Examples of the sorbitan fatty acid ester (C) include esters produced by sorbitan and fatty acid with carbon numbers of 16 to 32 such as stearic acid, behenic acid or montanoic acid. Use of fatty acids with carbon numbers of less than 12 may not provide improvement with use of polybutylene terephthalate and polyester elastomer. Use of fatty acids with more than 32 carbons may lower the heat resistance. Examples of especially preferred esters include sorbitan monostearate, sorbitan distearate, and sorbitan tristearate. In terms of adhesiveness properties, sorbitan tristearate is particularly preferable. The sorbitan fatty acid ester (C) used in the invention can be manufactured by common processes and is preferably adjusted with a degree of esterification so as to have a hydroxyl value of more than 50 and less than 400, more preferably 100 to 300, and further more preferably 150 to 300. A description of how to measure the hydroxyl value is provided below. If the hydroxyl value is less than 50, the capability of increasing compatibility between the polybutylene terephthalate and polyester elastomer is poor. If the hydroxyl value is more than 400, heat resistance becomes lower. The amount of sorbitan fatty acid ester (C) to be used is in the range of 0.01 to 5 parts by weight based on 100 parts of the total of (A) component and (B) component in the resin composition, and preferably 0.1 to 1 parts by weight. If the amount used is less than 0.01 parts by weight, the capability of increasing compatibility between the polybutylene terephthalate and polyester elastomer becomes small, and if the amount exceeds 3 parts by weight, the mechanical properties are lowered.

The following normal additives and some small amount of other polymers can be added to the polyester resin composition of the present invention unless they diminish the effect of the invention. Examples of the normal additives and other polymers include resin components, flame retardants, mold-releasing agents, phosphorus-based antioxidants, stabilizers, ultraviolet absorbers, coloring agents, lubricants, and inorganic fillers.

As to the resin components, any resin which is melt-moldable can be used. Examples of such resins include polycarbonate resins, polyethylene terephthalate resins, polybutylene naphthalene dicarboxylate resins, polyethylene naphthalene dicarboxylate resins, polypropylene terephthalate resins, ABS resins (acrylonitrile/butadiene/styrene copolymers), AS resins (acrylonitrile/styrene copolymers), hydrogenated or non-hydrogenated SBS resins (styrene/butadiene/styrene triblock copolymers), hydrogenated or non-hydrogenated SIS resins (styrene/isoprene/styrene triblock copolymers), SEBS resins (hydrogenated styrene/butadiene/styrene triblock copolymers), polyethylene resins, polypropylene resins, polymethylpentene resins, cyclic olefin-type resins, cellulose-type resins such as acetylcellulose, polyamide resins, polyacetal resins, polysulphone resins, polyphenylene sulfide resins, polyether ether ketone resins, polyimide resins, and polyetherimide resins, with each of these being used alone or in combination with one or more of these.

As to the flame retardant, any material to provide the resin with flame retardance can generally be used without limitation. Examples of such flame retardants include bromine-based flame retardants, phosphorus-based flame retardants, nitrogen compound-based flame retardants, silicone-based flame retardants, and inorganic-type flame retardants. Each of these can be used by itself or in combination with one or more others. A mixture of bromine-based flame retardant and inorganic-type flame retardant is a preferable example.

Examples of the preferable bromine-based flame retardant include brominated phenol novolac epoxy resins such as tetrabromobisphenol-A, tetrabromobisphenol-A derivatives, tetrabromobisphenol-A-epoxy oligomers or polymers, tetrabromobisphenol-A-carbonate oligomers or polymers, or brominated phenol novolac epoxys; poly(pentabromobenzyl polyacrylate); pentabromobenzyl polyacrylate; and N,N′-ethylene-bis-tetrabromophthalimide.

Of these, tetrabromobisphenol-A-epoxy oligomers or polymers and tetrabromobisphenol-A-carbonate oligomers or polymers are preferable.

Examples of the inorganic-type flame retardant used in the present invention include magnesium hydroxide hydrate, aluminum hydroxide hydrate, antimony trioxide, antimony pentoxide, sodium antimonite, zinc hydroxystannate, zinc stannate, metastannic acid, tin oxide, and zinc borate. Of these, antimony trioxide is preferable.

As to the mold-releasing agent, plant-based waxes such as carnauba wax and rice wax; animal waxes such as bees wax and lanolin; mineral-based waxes such as montan wax; petroleum-derived waxes such as paraffin wax and polyethylene wax; and fat/oil based waxes such as ricinus and the derivatives thereof, and fatty acids and the derivatives thereof.

Examples of the phosphorus-based antioxidant include trisnonylphenyl phosphite, and distearyl pentaerythritol diphosphite.

Examples of the stabilizer include benzotriazole-based compounds such as 2-(2′-hydroxy-5′-methylphenyl)benzotriazole; benzophenone-based compounds such as 2,4-dihydroxy benzophenone; and phosphoric esters such as mono- or di-stearyl phosphate, and trimethyl phosphate.

These variety of additives can be used together by selecting a plurality of additives, which may provide some synergistic effects.

Additives described above as an antioxidant may also work as a stabilizer and/or ultraviolet absorber. Some stabilizer may also have an antioxidant ability and/or ultraviolet absorbing ability. That is, the above described classification is for convenience and does not limit the function.

Examples of the ultraviolet absorbers include benzophenone-based ultraviolet absorbers such as 2-hydroxy-4-n-dodecyloxybenzophenone, 2,2′-dihydroxyl-4,4′-dimethoxybenzophenone, bis(5-benzoyl-4-hydroxy-2-methoxyphenyl)methane; and benzotriazole-based ultraviolet absorbers such as 2-(2′-hydroxy-5′-methylphenyl)benzotriazole, 2-(2′-hydroxy-3′,5′-di-tert-amylphenyl)benzotriazole, 2-(2′-hydroxy-3′,5′-bis(α,α′-dimethylbenzyl)phenyl benzotriazole, 2,2′ methylenebis[4-(1,1,3,3-tetramethylbutyl)-6-(2H-benzotriazole-2-yl)phenol], and a condensation material with methyl-3-[3-tert-butyl-5-(2H-benzotriazole-2-yl)-4-hydroxyphenylpropionate-polyethylene glycol.

The examples also include hindered amine-based light stabilizers such as bis(2,2,6,6-tetramathyl-4-piperidyl)sebacate, bis(1,2,2,6,6-pentamethyl-4-piperidyl)sebacate, tetrakis(2,2,6,6-tetramethyl-4-piperidyl)-1,2,3,4-butanetetracarboxylate, tetrakis(1,2,2,6,6-pentamethyl-4-piperidyl)-1,2,3,4-butanetetracarboxylate, poly{[6-(1,1,3,3-tetramethylbutyl)amino-1,3,5-triazine-2,4-diyl][(2,2,6,6-tetramethyl piperidyl)imino]hexamethylene[(2,2,6,6-tetramethyl piperidyl)imino]}, and polymethylpropyl 3-oxy-[4-(2,2,6,6-tetramethyl)piperidinyl]siloxane. Such light stabilizers used together with the ultraviolet absorber and/or various antioxidants can improve performance with respect to weather resistance.

As the coloring agent, organic dye stuffs, organic pigments, and/or inorganic pigments can be used. Also the following can be used: fluorescent whiteners, light-accumulating pigments, fluorescence dyestuffs, fluidity modifiers, organic-antimicrobial agents, inorganic-antimicrobial agents, photocatalytic antifouling agents, infrared absorbers, and photochromic agents.

Examples of the inorganic filler include glass fibers, carbon fibers, ceramic fibers, boron fibers, potassium titanate fibers, inorganic fibers such as asbestos fibers, calcium carbonate, highly-dispersive silicate, alumina, aluminum hydroxide, talc, clay, mica, glass flakes, powdered glass, glass beads, quartz powder, silica, wollastonite, carbon black, barium sulfate, casting plaster, silicon carbide, alumina, powdered material of boron nitride or silicon nitride, plate-like inorganic compounds, and whiskers. These inorganic fillers can be used alone or in a combination of two or more when needed.

It is preferable that blended components mentioned above are uniformly dispersed in the thermoplastic polyester resin of the invention and any blending method can be used. Usually the components are melted and kneaded at 200-350° C. in a common melting mixer such as single or twin screw extruder, Bunbury mixer, kneader, or mixing rolls. Also components can be blended in advance and then melted/kneaded. Moisture attached to each component should preferably be removed, such that it is desirable to dry each component in advance. However it is not necessary to dry all of the components.

When the twin screw extruder is used, a combination of fully flighted screws and a kneading disc is used. To obtain the composition of the present invention, uniform kneading by the screws is needed. For that, the total length of the kneading disc (kneading zone) should preferably account for 5 to 50% of total length of the screw, and more preferably 10 to 40%.

In performing melting and kneading in the invention, it is preferable for feeding each component to use an extruder with two feeding openings, and to feed (A) polybutylene terephthalate resin, (B) polyester elastomer resin, (C) sorbitan fatty acid ester, and other components when needed, through the main feeding opening (loading port) located on the end opposite of the discharging side of extruder.

The thermoplastic polyester resin composition of the present invention can be molded using any common process of injection molding, extruding molding, blow molding, press molding, fiber spinning and a variety of molded articles are produced. Examples of the molded articles include injection molded articles, extrusion molded articles, blow molded articles, films, sheets, and fibers. Examples of the films include various films such as non-stretched films, and uniaxially-stretched or biaxial stretched films. Examples of the fiber include non-stretched yarn, stretched yarn, and superdrawn yarn. In particular, the resin composition of the invention can be molded to produce an injection molded article which has a thin wall portion with a thickness of 0.01 to 1.0 mm.

The above-described molded products can be employed in the form of a variety of articles such as automobile parts, electric/electronic parts, building components, a variety of containers, daily use articles, groceries, and sanitary goods. Examples of specific articles include automobile under hood parts such as an air-flow meter, air pump, thermostat housing, engine mount, ignition bobbin, ignition case, clutch bobbin, sensor housing, idle speed control valve, vacuum switching valve, ECU housing, vacuum pump case, inhibitor switch, rotation sensor, acceleration sensor, distributor cap, coil base, ABS actuator case, top and bottom of radiator tank, cooling fan, fan shroud, engine cover, cylinder head cover, oil cap, oil pan, oil filter, fuel cap, fuel strainer, distributer cap, vapor canister housing, air cleaner housing, timing belt cover, break booster parts, various types of cases, tubes, tanks, hoses, clips, valves, and pipes; an interior automotive trim such as a torque control lever, safety belt parts, register blade, washer lever, knob of window regulator handle, passing light lever, sun visor bracket, and a variety of motor housings; exterior automobile trim such as a roof rail, fender, garnish, bumper, door mirror stay, spoiler, hood louver, wheel cover, wheel cap, grille apron cover frame, lamp reflector, lamp bezel, and door handle; various types of connectors for automobile such as wire harness connector, SMJ connector, PCB connector, door grommets connector; electric/electronic parts such as a connector for electric/electronic devices, relay case, coil bobbin, optical pick-up chassis, motor case, lap-top computer housing and the internal parts, CRT display housing and the internal parts, printer housing and the internal parts, mobile phone, mobile computer, housing for hand-held type mobile terminal and the internal parts, recording medium (CD, DVD, PD, FDD etc.) drive housing and the internal parts, copy machine housing and the internal parts, facsimile machine housing and the internal parts, and parabola antenna; further VTR parts, TV parts, clothes iron, hair dryer, rice cooker parts, microwave oven parts, audio equipment parts, parts for video equipment such as video camera and projector; substrate for optical recording medium such as laser disc (registered trade mark), compact disc (CD), CD-ROM, CD-R, CD-RW, DVD-ROM, DVD-R, DVD-RW, DVD-RAM, blu-ray disc; parts for home/office electric appliance such as lighting parts, refrigerator parts, air conditioner parts, typewriter parts, and word processor parts. Other examples include housings and the internal parts for electronic music instruments, home game machines, and mobile game machines; electric/electronic parts such as various types of gears, various types of cases, sensors, LEP lamps, connectors, sockets, resistors, relay cases, switches, coil bobbins, condensers, variable capacity cases, optical pick-ups, oscillators, various types of terminal assemblies, transformers, plugs, printed-wiring boards, tuners, speakers, microphones, headphones, miniature motors, magnetic head bases, power modules, semi-conductors, liquid crystals, FDD carriages, FDD chassis, motor blush holders, transformer members, and coil bobbins; building components such as wheels of sash, blind/curtain parts, plumbing joints, curtain liners, blind parts, gas meters, water meters, water boiler parts, roof panels, insulated walls, adjusters, staircases, doors, and floors; products for the fishing industry such as fishing line, fishing nets, nets for sea weed cultivation, and bait bags for fishing; civil engineering materials such as vegetation nets, vegetation mats, weed killing bags, weed killing nets, curing sheets, slope protection sheets, dust prevention sheets, drain sheets, water holding sheets, sludge dehydration sheets, and concrete formwork; mechanical parts such as gear wheels, screws, springs, bearings, levers, key stems, cams, ratchets, rollers, water supply parts, toy parts, fans, guts, pipes, cleaning zigs, motor parts, microscopes, binoculars, cameras, clocks and watches; agricultural materials such as multi films, films for tunnels, bird nets, vegetation protect nonwoven sheets, seeding pots, vegetation piles, seed tapes, budding sheets, greenhouse sheets, slow acting fertilizers, root-proof sheets, garden nets, flyscreens, young tree nets, print-laminates, fertilizer bags, feedstuff bags, sandbags, animal damage preventing nets, and windbreak nets; sanitary goods such as disposable diapers, hygiene product wrapping materials, cotton swabs, wet wipes, and toilet seat wipes; medical supplies such as medical nonwoven cloth (stitched portion reinforcing material, adhesion prevention film, prosthesis mending material), cut covering materials, cut tape bandages, suture threads, fracture reinforcing members, and medical films; containers and dinnerware such as calendars, stationary, clothing materials, food wrapping films, trays, blisters, knives, forks, spoons, tubes, plastic cans, pouches, containers, tanks, and baskets; containers and packages such as cooking containers for microwave ovens, cosmetics containers, wraps, plastic foamed cushioning materials, laminated paper, shampoo bottles, beverage bottles, cups, candy wrapping, shrink labels, lid materials, envelopes with windows, fruit baskets, easy peel packages, egg packs, HDD packages, compost bags, recording medium packages, shopping bags, and wrapping film for electric/electronic parts; various types of clothing material such as composite natural fibers, polo shirts, T-shirts, inners, uniforms, sweaters, socks, and neck ties; interior goods such as curtains, cloth for chair seats, carpets, table cloths, futons, wall paper, and wrapping cloth; hot melt binders for carrier tapes, print lamination, thermal screen printing films, releasing films, porous films, container bags, credit cards, cash cards, ID cards, IC cards, paper, and leather; powdered binder for magnetic materials, zinc sulfide or electrode materials; optical elements, electrically conductive emboss tapes, IC trays, golf tees, garbage bags, shopping plastic bags, various types of nets, tooth brushes, stationary, water draining nets, body towels, hand towels, tea bags, drain ditch filters, clear files, coating materials, adhesive materials, bags, chairs, tables, cool boxes, rakes, hose reels, planters, hose nozzles, dining tables, desk surfaces, furniture panels, kitchen cabinets, pen caps, and gas lighters. The resin composition of the present invention has excellent fluidity, toughness and durability together, which makes this material especially suitable for use as connector as well as in automobile and electric/electronic devices.

### EXAMPLES

The invention is explained in more detail based on the following examples.

Labels used for materials in Examples 1-7 and Comparative Examples 1-6 are described below.
(A) Polybutylene terephthalate resin

A-1: “1200S” made by Toray Industries, Inc.
(B) Elastomer
B-0: polyester elastomer resin—“Hytrel 4047” made by Du Pont-Toray Co., Ltd
(b1) a copolymer containing a glycidyl group made of α-olefin and α, β-glycidyl esters of unsaturated acids.
B-1: ethylene/glycidyl methacrylate copolymer—“ETX-6” made by Sumitomo Chemical Co., Ltd
B-3: ethylene/methacrylate/glycidyl methacrylate copolymer—“BF7M” made by Sumitomo Chemical Co., Ltd
(b2) copolymer formed by copolymerization of 2 or more types of α-olefins.
B-2: ethylene/1-butene copolymer “TAFMER-TX-610” made by Mitsui Chemicals, Inc.
B-4: ethylene/ethyl acrylate copolymer—“A709” made by DuPont Mitsui.
(C) Sorbitan fatty acid ester

C-1: sorbitan monostearate—“Poem S-60V” made by Riken Vitamin Co., Ltd. E

C-2: sorbitan distearate

C-3: sorbitan tristearate—“Poem S-65V” made by Riken Vitamin Co., Ltd.

C-4: glycerin monostearate

Evaluations for toughness and adhesiveness of the Examples and Comparative Examples are described below.

### (1) Toughness (Tensile Elongation)

According to ISO 527-1, tensile strength and fracture elongation are measured.

### (2) Adhesiveness Evaluation

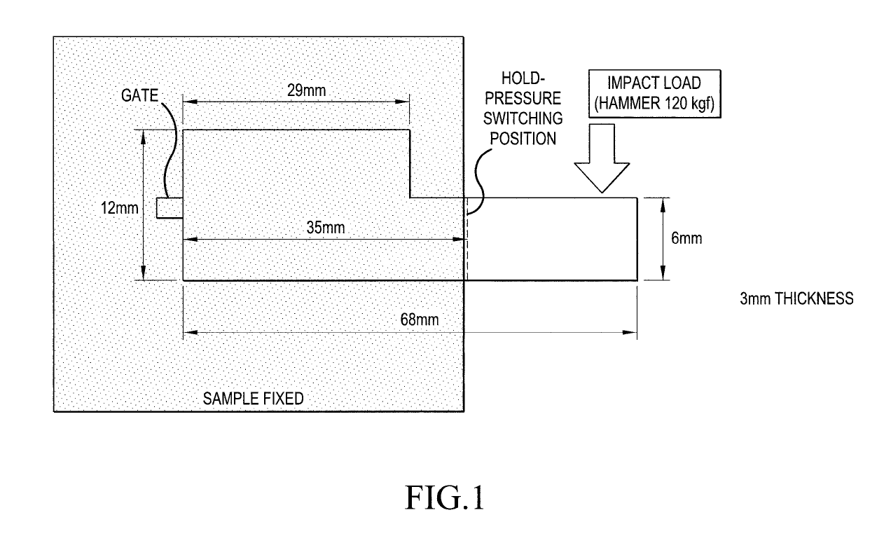

Using a mold tool that can make a 3 mm thickness experimental piece with a shape as shown in FIG. 1, injection was performed under the following conditions: cylinder temperature: 260/260/260/250/240° C. and the mold tool temperature 40° C. After passing the resin through the middle of the cylinder, the resin was injected from the gate of the mold tool at an injection speed of 25 mm/sec and with a primary pressure of 45 MPa within the mold tool. The resin flow was stopped for 4 seconds at a stage where the resin had reached a hold pressure switching position in the mold tool, and subsequently, after applying 50 MPa of the hold pressure for 5 seconds, the mold tool was filled with the resin. In this way, an adhesion defect imperfection portion was deliberately formed at the hold pressure switching position.

Next, after removing the experimental piece from the mold tool, the experimental piece was fixed at the hold pressure switching position as shown in FIG. 1. Using a 120 kgf hammer, and at a lifting angle of 150°, an Izod impact test was performed. The test was carried out N=50 times. In the evaluation, it was determined how many times destruction occurred out of the 50 tests.

### Examples 1-20

As shown in Table 1 and 3, each Example had a different composition. Each of components (A), (B), (C) and other additives of each of the examples were fed through the loading port of the twin screw extruder. The cylinder temperature was 250° C. The diameter of the screw was 57 mm.

The strand discharged from the die was cooled in the cooling bath and then pelletized with a strand cutter. After each pellet was dried with hot air at 130° C. for 3 hours or more, test pieces were prepared, and the toughness and adhesiveness properties were evaluated. The results are shown in Tables 1 and 3. Test pieces of all examples showed unexpected and excellent toughness and compatibility between the polybutylene terephthalate and polyester elastomer resin and/or olefin elastomer resin.

By comparing Examples 1 to 3 or Examples 8 to 10, the following is understood. If the amount of the (C) component is in the range of 0.01 to 5 parts by weight, a thermoplastic polyester resin composition can be obtained that has excellent toughness and adhesiveness.

By comparing Examples 2, 4 and 5 or Examples 9, 11 and 12, the following is understood. If the (C) component is sorbitan tristearate, the adhesiveness of the thermoplastic polyester resin composition is further improved.

By comparing Examples 2, 6, and 7 or Examples 9, 13, and 14, the following is understood. If the amount of the (A) component is in the range of 75 to 99 wt % and the (B) component is in the range of 1 to 25 wt %, a thermoplastic polyester resin composition can be obtained that has excellent toughness and adhesiveness.

By comparing Examples 9, 15, 16 and 20 or Examples 13, 17 and 18, the following is understood. If the olefin elastomer is made of a mixture of the (b1) component and the (b2) component, the adhesiveness of the thermoplastic polyester resin composition is dramatically improved.

From Example 19, the following is understood. If the component (B) is a resin containing a polyester elastomer resin and a olefin elastomer resin that is a mixture of the component (b1) and the component (b2), a thermoplastic polyester resin can be obtained that has unusually excellent toughness and adhesiveness.

### Comparative Examples 1-14

An experimental piece was formed in the same way as in Example 1 except for changing the composition of the resin composition as shown in Tables 2 and 4. Every kind of evaluation was performed. The obtained composition showed some degradation in toughness and adhesiveness.

Because the component (C) was not included in the Comparative Examples 1, 7, 13 and 14, the adhesiveness was remarkably reduced.

Because the component (B) was not included in Comparative Examples 2 and 8, the adhesiveness was remarkably reduced.

Because the amount of the component (B) was less than 1.0 wt % in Comparative Examples 3 and 9, it was not possible to obtain sufficient adhesiveness.

Because the amount of the component (C) included in Comparative Examples 4 and 10 was less than 0.01 wt parts, it was not possible to obtain sufficient adhesiveness.

Because the amount of the component (C) in Comparative Examples 5 and 11 exceeded 5 parts by weight, it was not possible to obtain sufficient adhesiveness.

Because the component (C) was not sorbitan fatty acid ester in Comparative Examples 6 and 12, it was not possible to obtain sufficient adhesiveness.

TABLE 1

| | | | Examples | | | | | | |
|---|---|---|---|---|---|---|---|---|---|
| | | | 1 | 2 | 3 | 4 | 5 | 6 | 7 |
| A-1 | polybutylene terephthalate | wt % | 95 | 95 | 95 | 95 | 95 | 80 | 98 |
| B-0 | polyester elastomer | wt % | 5 | 5 | 5 | 5 | 5 | 20 | 2 |
| C-1 | sorbitan monostearate | parts wt | | | | | 0.5 | | |
| C-2 | sorbitan distearate | parts wt | | | | 0.5 | | | |
| C-3 | sorbitan tristearate | parts wt | 0.1 | 0.5 | 4 | | | 0.5 | 0.5 |
| C-4 | glycerin monostearate | parts wt | | | | | | | |
| toughness | tensile strength | MPa | 55 | 55 | 54 | 55 | 55 | 35 | 55 |
| | tensile elongation | % | 20 | 20 | 18 | 20 | 20 | 50 | 15 |

| | | | | | | | | |
|---|---|---|---|---|---|---|---|---|
| adhesive evaluation | — | 8 | 1 | 7 | 9 | 13 | 22 | 3 |

TABLE 2

| | | | Examples | | | | | |
|---|---|---|---|---|---|---|---|---|
| | | | 1 | 2 | 3 | 4 | 5 | 6 |
| A-1 | polybutylene | wt % | 95 | 100 | 99.5 | 95 | 95 | 95 |
| | terephthalate | | | | | | | |
| B-0 | polyester | wt % | 5 | | 0.5 | 5 | 5 | 5 |
| | elastomer | | | | | | | |
| C-1 | sorbitan | parts wt | | | | | | |
| | monostearate | | | | | | | |
| C-2 | sorbitan | parts wt | | | | | | |
| | distearate | | | | | | | |
| C-3 | sorbitan | parts wt | | 0.5 | 0.5 | 0.005 | 6 | |
| | tristearate | | | | | | | |
| C-4 | glycerin | parts wt | | | | | | 0.5 |
| | monostearate | | | | | | | |
| toughness | tensile strength | MPa | 55 | 55 | 55 | 55 | 45 | 55 |
| | tensile elongation | % | 20 | 10 | 12 | 20 | 7 | 20 |

| | | | | | | | |
|---|---|---|---|---|---|---|---|
| adhesive evaluation | — | 50 | 49 | 39 | 41 | 50 | 41 |

TABLE 3

| | | | Examples | | | | | | | | | | | | |
|---|---|---|---|---|---|---|---|---|---|---|---|---|---|---|---|
| | | | 8 | 9 | 10 | 11 | 12 | 13 | 14 | 15 | 16 | 17 | 18 | 19 | 20 |
| A-1 | polybutylene terephthalate | wt % | 95 | 95 | 95 | 95 | 95 | 80 | 98 | 95 | 95 | 80 | 80 | 92.5 | 95 |
| B-0 | polyester elastomer | wt % | | | | | | | | | | | | 2.5 | |
| B-1 | elastomer | wt % | 5 | 5 | 5 | 5 | 5 | 20 | 2 | 2.5 | | 10 | | | |
| B-2 | elastomer | wt % | | | | | | | | 2.5 | | 10 | | | 5 |
| B-3 | elastomer | wt % | | | | | | | | | 2.5 | | 10 | 2.5 | |
| B-4 | elastomer | wt % | | | | | | | | | 2.5 | | 10 | 2.5 | |
| C-1 | sorbitan monostearate | parts wt | | | | | 0.5 | | | | | | | | |
| C-2 | sorbitan distearate | parts wt | | | | 0.5 | | | | | | | | | |
| C-3 | sorbitan tristearate | parts wt | 0.1 | 0.5 | 4 | | | 0.5 | 0.5 | 0.5 | 0.5 | 0.5 | 0.5 | 0.5 | 0.5 |
| C-4 | glycerin monostearate | parts wt | | | | | | | | | | | | | |
| toughness | tensile strength | MPa | 55 | 55 | 55 | 55 | 55 | 35 | 55 | 55 | 55 | 35 | 35 | 35 | 55 |
| | tensile elongation | | 25 | 25 | 22 | 25 | 25 | 100 | 17 | 30 | 30 | 120 | 110 | 130 | 25 |

| | | | | | | | | | | | | | | |
|---|---|---|---|---|---|---|---|---|---|---|---|---|---|---|
| adhesiveness evaluation | — | 7 | 2 | 8 | 9 | 18 | 2 | 3 | 0 | 0 | 0 | 0 | 0 | 5 |

TABLE 4

| | | | Examples | | | | | | | |
|---|---|---|---|---|---|---|---|---|---|---|
| | | | 7 | 8 | 9 | 10 | 11 | 12 | 13 | 14 |
| A-1 | polybutylene terephthalate | wt % | 95 | 100 | 99.5 | 95 | 95 | 95 | 95 | 95 |
| B-1 | elastomer | wt % | 5 | | 0.5 | 5 | 5 | 20 | 2.5 | |
| B-2 | elastomer | wt % | | | | | | | 2.5 | |
| B-3 | elastomer | wt % | | | | | | | | 2.5 |
| B-4 | elastomer | wt % | | | | | | | | 2.5 |
| C-1 | sorbitan monostearate | parts wt | | | | | | | | |
| C-2 | sorbitan distearate | parts wt | | | | | | | | |
| C-3 | sorbitan tristearate | parts wt | | 0.5 | 0.5 | 0.005 | 6 | | | |
| C-4 | glycerin monostearate | parts wt | | | | | | 0.5 | | |
| toughness | tensile strength | MPa | 55 | 55 | 55 | 55 | 48 | 55 | 55 | 55 |
| | tensile elongation | % | 25 | 13 | 15 | 25 | 8 | 20 | 30 | 30 |

| | | | | | | | | | |
|---|---|---|---|---|---|---|---|---|---|
| adhesive evaluation | — | 50 | 48 | 42 | 41 | 49 | 37 | 48 | 48 |

What is claimed is:

1. A thermoplastic polyester resin composition comprising:
100 parts by weight total of a resin composition, said resin composition comprising:
(A) 75 to 99 wt % of a polybutylene terephthalate resin, and
(B) 1.0 to 25 wt % of a polyester elastomer resin and/or an olefin elastomer; and
0.01 to 5 parts by weight of (C) a sorbitan fatty acid ester.

2. The thermoplastic polyester resin composition according to claim 1, wherein the sorbitan fatty acid ester (C) is a sorbitan monostearate, a sorbitan distearate or a sorbitan tristearate.

3. The thermoplastic polyester resin composition according to claim 1, wherein (B) olefin elastomer is a mixture of (b1) a copolymer containing a glycidyl group made of α-olefin and α, β-glycidyl esters of unsaturated acids and of (b2) a copolymer formed by copolymerization of 2 or more types of α-olefins, and with respect to the total of (A) component and (B) component in the resin composition, (b1) is in a range of 0.5 to 24.5 wt % and (b2) is in a range of 0.5 to 24.5 wt %.

4. The thermoplastic polyester resin composition according to claim 2, wherein (B) olefin elastomer is a mixture of (b1) a copolymer containing a glycidyl group made of α-olefin and α, β-glycidyl esters of unsaturated acids and of (b2) a copolymer formed by copolymerization of 2 or more types of α-olefins, and with respect to the total of (A) component and (B) component in the resin composition, (b1) is in a range of 0.5 to 24.5 wt % and (b2) is in a range of 0.5 to 24.5 wt %.

5. A molded article made of the thermoplastic polyester resin composition according to claim 1.

6. A molded article made of the thermoplastic polyester resin composition according to claim 2.

7. A molded article made of the thermoplastic polyester resin composition according to claim 3.

8. A molded article made of the thermoplastic polyester resin composition according to claim 4.

9. A connector made of the molded article according to claim 3.

10. A connector made of the molded article according to claim 4.

11. The thermoplastic polyester resin composition according claim 1, wherein (B) is the polyester elastomer resin and olefin elastomer.

12. The thermoplastic polyester resin composition according claim 1, wherein (B) is the olefin elastomer.

13. The thermoplastic polyester resin composition according claim 11, wherein (B) is selected from the group consisting of an ethylene/propylene copolymer, ethylene/1-butene copolymer, ethylene/1-octene copolymer, ethylene/propylene/conjugated diene copolymer, ethylene/ethyl acrylate copolymer, ethylene/butyl acrylate copolymer, ethylene/methacrylic acid copolymer, ethylene/glycidyl acrylate copolymer, ethylene/glycidyl methacrylate copolymer, ethylene/methyl acrylate/glycidyl methacrylate copolymer, ethylene/ethyl acrylate/glycidyl methacrylate copolymer, ethylene/vinyl acetate/glycidyl methacrylate copolymer, ethylene/ethyl acrylate-g-methyl methacrylate/butyl acrylate copolymer, ethylene/ethyl acrylate-g-methyl methacrylate copolymer, ethylene/ethyl acrylate-g-maleic anhydride copolymer, ethylene/methyl acrylate-g-maleic anhydride copolymer, ethylene/ethyl acrylate-g-maleimide copolymer, ethylene/propylene-g-maleic anhydride copolymer, ethylene/butene-1-g-maleic anhydride copolymer, and mixtures thereof.

14. The thermoplastic polyester resin composition according claim 13, wherein (B) is ethylene/1-butene copolymer or ethylene/ethyl acrylate copolymer.
